(19) United States
(12) Patent Application Publication
(10) Pub. No.: US 2004/0248719 A1
(43) Pub. Date: Dec. 9, 2004

(54) Preforming system

(76) Inventors: Keiji Yano, Tokyo (JP); Isao Tezuka, Tokyo (JP); Nobuo Katoh, Tokyo (JP); Kozo Yoshida, Tokyo (JP)

Correspondence Address: Lorusso Loud & Kelly, 3137 Mt Vernon Avenue, Alexandria, VA, 22305, US

(21) Appl. No.: 10/491,540

(22) PCT Filed: Oct. 7, 2002
(86) PCT No.: PCT/JP02/10415

(30) Foreign Application Priority Data
Oct. 10, 2001 (JP) 2001-312480

(51) Int. Cl. B31C 1/00

(52) U.S. Cl. 493/269

(57) ABSTRACT

An object is to provide a preforming apparatus allowing smooth travel of a packaging material (11). The preforming apparatus includes first to fourth guides (34 to 37) for forming a web-like packaging material (11) into a tubular packaging material (11); a longitudinal sealing device (41) for longitudinally sealing the tubular packaging material (11); a drive unit; and a tube guide device (38) disposed in such a manner as to surround the tubular packaging material (11), and guiding the tubular packaging material (11) while being driven by means of the drive unit. Activation of the drive unit causes the tube guide device (38) to guide and feed the packaging material (11), thereby preventing the tube guide device (38) from resisting travel of the packaging material (11). Thus, the tube guide device (38) does not yield a braking effect, thereby allowing smooth travel of the packaging material (11). Also, high tension along the traveling direction of the packaging material (11) does not arise in the packaging material (11) when the packaging material (11) travels between the tube guide device (38) and the first or second sealing jaw device (44 or 45).

### TECHNICAL FIELD

The present invention relates to a preforming apparatus.

### BACKGROUND ART

Conventionally, during production of packaging containers that contain liquid food such as milk or a soft drink, a web-like packaging material formed of a flexible laminated material is formed into a tubular shape; and while the thus-formed tubular packaging material is being filled with liquid food, the tubular packaging material is sealed and cut at predetermined intervals, thereby yielding brick-like packaging containers.

FIG. 1 is a schematic view showing a conventional filling apparatus.

In FIG. 1, reference numeral 11 denotes a web-like packaging material formed of a flexible laminated material. The packaging material 11 is produced by an unillustrated packaging-material production machine; set, in the form of a reel 12, on a delivery unit 13; delivered by means of the delivery unit 13; and caused to travel through the filling apparatus by means of a feed apparatus.

While the packaging material 11 is traveling, an unillustrated hole is punched in the packaging material 11, and an unillustrated inner tape and an unillustrated pull tab are affixed to the packaging material 11 in such a manner as to cover the punched hole. Subsequently, the packaging material 11 is caused to travel vertically. While being guided by means of a plurality of guides 15 disposed along the traveling direction, the vertically traveling packaging material 11 is formed into a tubular shape. The tubular packaging material 11 is sealed in the longitudinal direction by means of an unillustrated sealing device.

While the tubular packaging material 11 is guided by means of a tube guide device 17, liquid food is supplied into the tubular packaging material 11 via a filling pipe 16. Next, by mean of unillustrated sealing jaw devices, the tubular packaging material 11 is nipped from opposite sides and is sealed laterally at predetermined longitudinal intervals. In combination with the gripping and sealing processes, a portion of the tubular packaging material 11 extending along the longitudinal interval is formed into a pillow-like prototype container 18 by means of unillustrated forming flaps.

Subsequently, the thus-formed prototype container 18 is cut at the laterally sealed portions; i.e., at the lateral seal portions. Then, the prototype container 18 undergoes forming along previously formed creases to thereby be formed into a brick-like packaging container that contains a predetermined amount of liquid food.

The feed apparatus generally includes a pair of nip rollers R1 (FIG. 1 shows only one of the paired nip rollers) disposed adjacent to the delivery unit 13 and adapted to feed the packaging material 11 while nipping the packaging material 11 from opposite sides; unillustrated crease rollers for forming creases on the packaging material 11 while being rotated; a pair of nip rollers R2 (FIG. 1 shows only one of the paired nip rollers) disposed at the highest position of the filling apparatus and adapted to feed the packaging material 11 while nipping the packaging material 11 from opposite sides; and unillustrated engagement portions formed integrally with the corresponding forming flaps and adapted to engage lug portions formed on the prototype container 18 in the vicinity of the lateral seal portions so as to move the prototype container 18 and the packaging material 11 forward as the forming flaps move.

The tube guide device 17 rotates as the packaging material 11 travels, and is composed of at least two support rollers, each of which has a predetermined curved surface for guiding the packaging material 11.

However, the conventional filling apparatus involves the following problem stemming from the curved surfaces of the support rollers. Since the peripheral speed of each rotating support roller differs along the curvature of the curved surface, the support rollers impart resistance to travel of the packaging material 11, thereby yielding a braking effect on the traveling packaging material 11 and thus hindering smooth travel of the packaging material 11.

An object of the present invention is to solve the above-mentioned problem in the conventional filling apparatus and to provide a preforming apparatus allowing smooth travel of a packaging material.

### DISCLOSURE OF THE INVENTION

To achieve the above object, a preforming apparatus of the present invention comprises a guide for forming a web-like packaging material into a tubular packaging material; a sealing device for longitudinally sealing the tubular packaging material; a drive unit; and a tube guide device disposed in such a manner as to surround the tubular packaging material, and guiding the tubular packaging material while being driven by means of the drive unit.

In this case, activation of the drive unit causes the tube guide device to guide and feed the packaging material, thereby preventing the tube guide device from resisting travel of the packaging material. Thus, the tube guide device does not yield a braking effect, thereby allowing smooth travel of the packaging material.

Thus, high tension along the traveling direction of the packaging material does not arise in the packaging material when the packaging material travels between the tube guide device and a sealing jaw device, thereby allowing smooth travel of the packaging material.

In another preforming apparatus of the present invention, the tube guide device is a support roller which receives rotation generated by means of the drive unit.

In a further preforming apparatus of the present invention, a plurality of the support rollers are provided.

In still another preforming apparatus of the present invention, each of the support rollers has a curved surface.

In a still further preforming apparatus of the present invention, the radius of curvature of the curved surface is substantially equal to that of the tubular packaging material.

In yet another preforming apparatus of the present invention, rotation is transmitted to the support rollers via corresponding one-way clutches.

In this case, since rotation is transmitted to the support rollers via the corresponding one-way clutches, the one-way clutches allow idle rotation of the corresponding support rollers when the traveling speed of the packaging material is higher than the peripheral speed of each support roller.

Thus, the support rollers do not resist travel of the packaging material and thus do not yield a braking effect, thereby allowing smooth travel of the packaging material.

In a still further preforming apparatus of the present invention, a plurality of the guides are disposed along the traveling direction of the packaging material for guiding the packaging material.

Further, the tube guide device is disposed downstream of the guides with respect to the traveling direction of the packaging material.

A still further preforming apparatus of the present invention further comprises a longitudinal sealing device for longitudinally sealing the packaging material.

Further, the tube guide device is disposed downstream of the longitudinal sealing device with respect to the traveling direction of the packaging material.

A still further preforming apparatus of the present invention further comprises a lateral sealing device for laterally sealing the packaging material.

Further, the tube guide device is disposed upstream of the lateral sealing device with respect to the traveling direction of the packaging material.

In this case, high tension along the traveling direction of the packaging material does not arise in the packaging material when the packaging material travels between the tube guide device and the lateral sealing device, thereby allowing smooth travel of the packaging material. Also, the position of formation of a punched hole, the position of affixment of an inner tape and a pull tab, the positions of lateral sealing portions, etc. do not shift; and the engagement portions do not damage the lug portions of a prototype container. As a result, quality of a packaging container can be enhanced.

### BRIEF DESCRIPTION OF DRAWINGS

FIG. 1 is a schematic view showing a conventional filling apparatus;

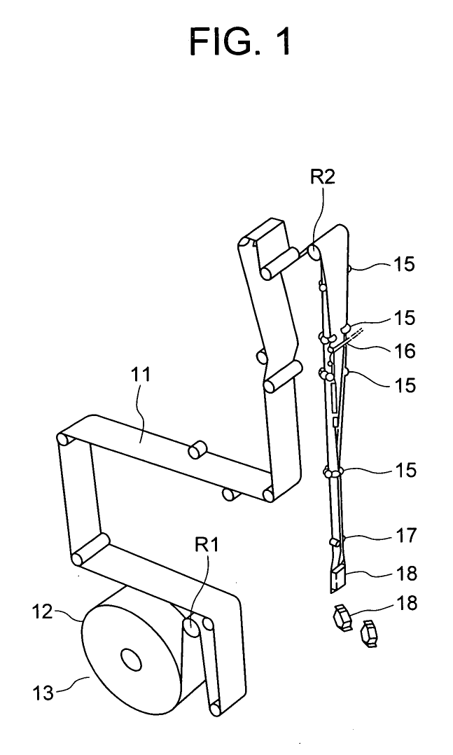

FIG. 2 is a perspective view showing a main portion of a filling apparatus according to an embodiment of the present invention;

FIG. 3 is a conceptual view showing the operation of sealing jaw devices in the embodiment of the present invention; and

FIG. 4 is a schematic view showing a tube guide device in the embodiment of the present invention.

### BEST MODE FOR CARRYING OUT THE INVENTION

The embodiment of the present invention will next be described in detail with reference to the drawings.

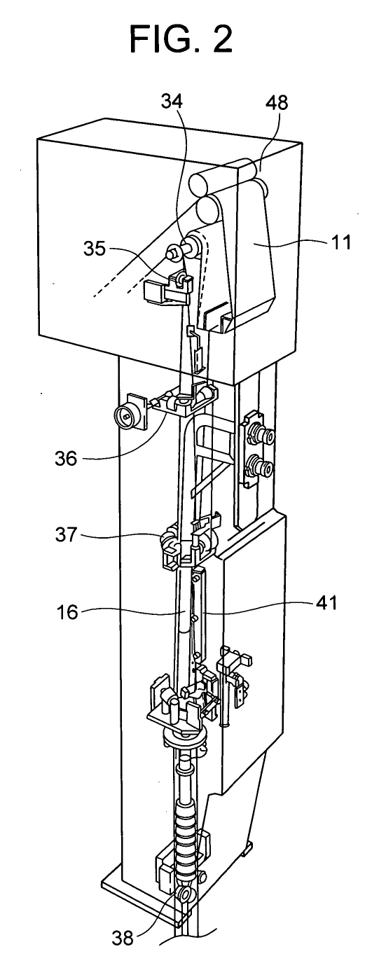

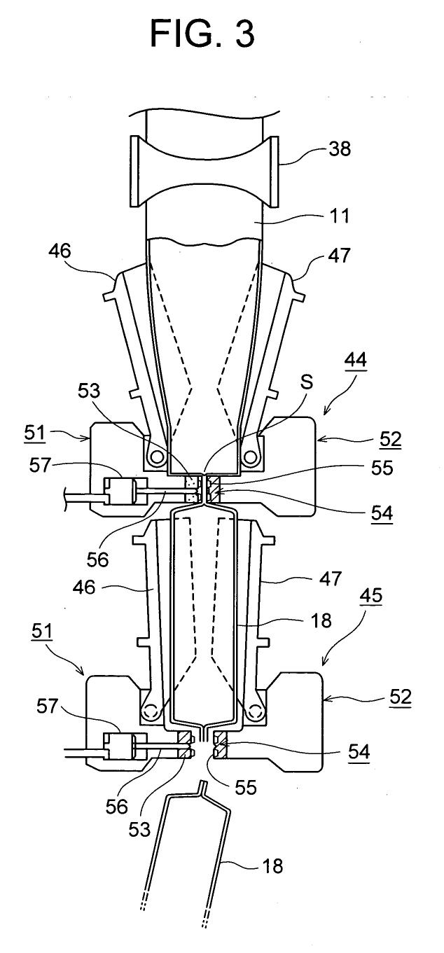

FIG. 2 is a perspective view showing a main portion of a filling apparatus according to the embodiment of the present invention; and FIG. 3 is a conceptual view showing the operation of sealing jaw devices in the embodiment of the present invention.

In FIGS. 2 and 3, reference numeral 11 denotes a web-like packaging material formed of a flexible laminated material. The packaging material 11 is produced by an unillustrated packaging-material production machine; set, in the form of a reel, on an unillustrated delivery unit; delivered by means of the delivery unit; and caused to travel through the filling apparatus by means of a feed apparatus.

While the packaging material 11 is traveling, an unillustrated hole is punched in the packaging material 11, and an unillustrated inner tape and an unillustrated pull tab are affixed to the packaging material 11 in such a manner as to cover the punched hole. Subsequently, as shown in FIG. 2, the packaging material 11 is caused to travel vertically. While being guided by means of first to fourth guides 34 to 37 disposed along the traveling direction, the vertically traveling packaging material 11 is formed into a tubular shape. The tubular packaging material 11 is sealed in the longitudinal direction by means of a longitudinal sealing device 41, which serves as a first sealing device. Therefore, each of the first to fourth guides 34 to 37 includes a forming ring having a predetermined curved surface in order to form the packaging material 11 into a tubular shape.

Subsequently, while the tubular packaging material 11 is guided by means of a tube guide device 38, which is disposed downstream of the fourth guide 37 and also downstream of the longitudinal sealing device 41 with respect to the traveling direction of the packaging material 11, liquid food is supplied into the tubular packaging material 11 from above via a filling pipe 16. Next, as shown in FIG. 3, by means of first and second sealing jaw devices 44 and 45, which are disposed downstream of the tube guide device 38 with respect to the traveling direction of the packaging material 11, the tubular packaging material 11 is nipped from opposite sides and is sealed laterally at predetermined longitudinal intervals. In combination with the gripping and sealing processes, a portion of the tubular packaging material 11 extending along the longitudinal interval is formed into a pillow-like prototype container 18 by means of forming flaps 46 and 47. Notably, the first and second sealing jaw devices 44 and 45 constitute a lateral sealing device, which serves as a second sealing device.

Subsequently, the thus-formed prototype container 18 is cut at the lateral seal portions by means of the first and second sealing jaw devices 44 and 45. Then, the prototype container 18 undergoes forming along previously formed creases to thereby be formed into a brick-like packaging container that contains a predetermined amount of liquid food.

The aforementioned feed apparatus generally includes an unillustrated pair of nip rollers disposed adjacent to the aforementioned delivery unit and adapted to feed the packaging material 11 while nipping the packaging material 11 from opposite sides; unillustrated crease rollers for forming creases on the packaging material 11 while being rotated; a pair of nip rollers 48 disposed at the highest position of the filling apparatus and adapted to feed the packaging material 11 while nipping the packaging material 11 from opposite sides; and unillustrated engagement portions formed integrally with the corresponding forming flaps 46 and 47 and adapted to engage lug portions formed on the prototype container 18 in the vicinity of the lateral seal portions so as to move the prototype container 18 and the packaging material 11 forward as the first and second sealing jaw devices 44 and 45 move.

Notably, a preforming apparatus is composed of the first to fourth guides 34 to 37, the longitudinal sealing device 41, the tube guide device 38, and the first and second sealing jaw devices 44 and 45, among others.

Next, the first to fourth guides 34 to 37 will be described.

The first guide 34 has a cylindrical shape and guides the traveling web-like packaging material 11 while reversing its travel direction. The second guide 35 curves opposite side edges of the web-like packaging material 1; the third guide 36 brings the curved opposite side edges of the web-like packaging material 11 to each other such that the packaging material 11 assumes a shape having a substantially elliptical cross section; and the fourth guide 37 brings further close to each other the opposite side edges of the packaging material 11 shaped in such a manner as to have a substantially elliptical cross section so as to impart a tubular shape to the packaging material 11.

Next, the first and second sealing jaw devices 44 and 45 will described.

As shown in FIG. 3, each of the first and second sealing jaw devices 44 and 45 has a cutting jaw 51 and a heat seal jaw 52.

In this case, while the packaging material 11 is fed downward in an intermittent manner, the first and second sealing jaw devices 44 and 45 having the same structure are alternatingly operated such that their operating cycles are shifted from each other by half cycle, thereby enhancing the processing speed of the filling apparatus.

The cutting jaw 51 has a cutting bar 53 provided at the front end (at the right-hand end in FIG. 3); the heat seal jaw 52 has a seal block (an inductor insulator) 54 provided at the front end (at the left-hand end in FIG. 3); and the seal block 54 has two inductors 55. The cutting jaw 51 and the heat seal jaw 52 are caused to advance so as to nip the packaging material 11 from opposite sides by means of the cutting bar 53 and the seal block 54. As a result, the opposite inner surfaces of the packaging material 11 are brought into mutuat contact, and the packaging material 11 is sealed laterally at the nipped portion, thereby forming a lateral seal portion S including two seal lines.

A laterally extending flat cutter knife 56 is provided at the center of the cutting jaw 51 in a reciprocatively movable condition (in a condition movable rightward and leftward in FIG. 3). The advancing cutter knife 56 (the cutter knife 56 moving rightward in FIG. 3) cuts the lateral seal portion S at an intermediate position between the two seal lines.

A cylinder 57 is disposed at the rear end (the left-hand end in FIG. 3) of the cutter knife 56 so as to advance and retreat the cutter knife 56 through supply of compressed air or the like to and release the same from the cylinder 57.

Forming flaps 46 and 47 are swingably attached to the cutting jaw 51 and the heat seal jaw 52, respectively, in such a manner as to surround and guide the packaging material 11, and are adapted to form the packaging material 11 into a pillow-like shape while guiding the packaging material 11.

In FIG. 3, the first sealing jaw device 44 is at the sealing-cutting start position. At the sealing-cutting start position, the first sealing jaw device 44 causes the cutting jaw 51 and the heat seal jaw 52 to advance so as to thereby nip the packaging material 11 from opposite sides, whereby the opposite inner surfaces of the packaging material 11 are brought into mutual contact. Then, while gripping the packaging material 11, the first sealing jaw device 44 moves downward. During the downward movement, the lateral seal portion S is formed, thereby forming the prototype container 18.

In FIG. 3, the second sealing jaw device 45 is at the sealing-cutting end position. Immediately before the second sealing jaw device 45 reaches the sealing-cutting end position, the cutter knife 56 of the second sealing jaw device 45 is caused to advance and cut the lateral seal portion S at an intermediate position between the two seal lines, thereby separating the prototype container 18.

After the lateral seal portion S is cut at an intermediate position between the two seal lines, the cutting jaw 51 and the heat seal jaw 52 of the second sealing jaw device 45 are caused to retreat and then move upward in a gyrating manner to the sealing-cutting start position. When, at the sealing-cutting start position, the second sealing jaw device 45 begins to operate such that the cutting jaw 51 and the heat seal jaw 52 begin to advance, the cutter knife 56 of the first sealing jaw device 44 advances and cuts the lateral seal portion S at an intermediate position between the two seal lines, thereby separating the prototype container 18.

Notably, each of the first and second sealing jaw devices 44 and 45 has an unillustrated cylinder mechanism. At the sealing-cutting start position, supply of compressed air or the like to the cylinder mechanism draws the cutting jaw 51 and the heat seal jaw 52 to each other, thereby increasing a pressing force involved in sealing.

Next, the tube guide device 38 will be described.

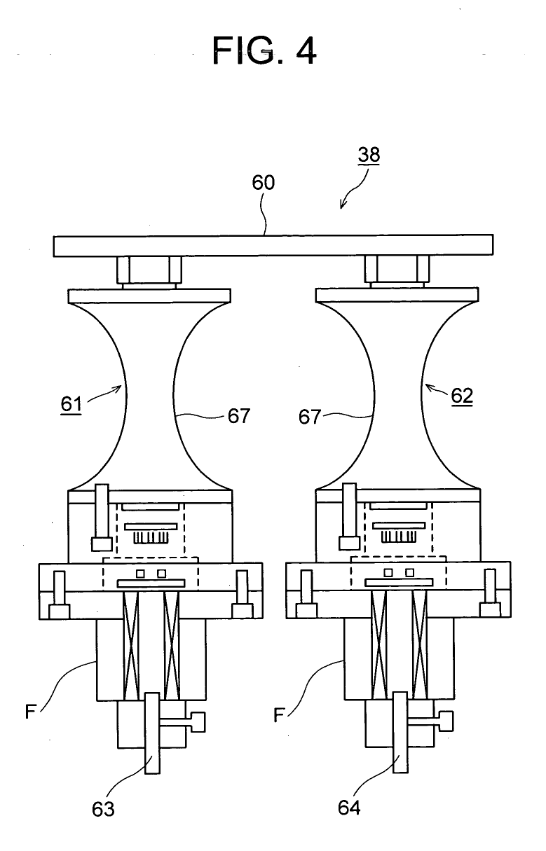

FIG. 4 is a schematic view showing the tube guide device in the embodiment of the present invention.

The tube guide device 38 is disposed downstream of the fourth guide 37 and upstream of the first and second sealing jaw devices 44 and 45 (FIG. 3), with respect to the traveling direction of the packaging material 11 (FIG. 2). The tube guide device 38 includes a support member 60; a plurality of support rollers (in the present embodiment, first and second support rollers 61 and 62); flexible drive cables 63 and 64 that connect the first and second support rollers 61 and 62 to an unillustrated drive motor, which serves as the drive unit; and one-way clutches F disposed between the first and second support rollers 61 and 62 and the corresponding drive cables 63 and 64. The drive motor is connected to the drive cables 63 and 64 via an unillustrated reduction gear.

Each of the first and second support rollers 61 and 62 has a predetermined curved surface 67 so that the first and second support rollers 61 and 62 disposed adjacent to each other can surround the tubular packaging material 11. In this case, the radius of curvature of the tubular packaging material 11 and that of the curved surface 67 are rendered substantially equal. The drive motor operates under instructions from an unillustrated control unit. Thus-generated rotation of the drive motor is reduced in speed by means of the reduction gear. The thus-speed-reduced rotation branches to thereby be transmitted to the first and second support rollers 61 and 62 via the drive cables 63 and 64, respectively.

The operating drive motor causes the first and second support rollers 61 and 62 to rotate in mutually opposite directions at the same speed, whereby the first and second support rollers 61 and 62 can guide the packaging material 11 and can frictionally feed the packaging material 11 through contact with the surface of the packaging material 11.

In this case, since the first and second support rollers 61 and 62 are rotated by means of the drive motor, the first and second support rollers 61 and 62 do not resist travel of the packaging material 11 and thus do not yield a braking effect, thereby allowing smooth travel of the packaging material 11.

Further, high tension along the traveling direction of the packaging material 11 does not arise in the packaging material 11 when the packaging material 11 travels between the tube guide device 38 and the first or second sealing jaw device 44 or 45, thereby allowing smooth travel of the packaging material 11. Also, the position of formation of a punched hole, the position of affixment of an inner tape and a pull tab, the positions of lateral sealing portions, etc. do not shift; and the aforementioned engagement portions do not damage the lug portions of the prototype container 18. As a result, quality of a packaging container can be enhanced.

Since the one-way clutches F are disposed between the first and second support rollers 61 and 62 and the drive cables 63 and 64, respectively, the one-way clutches F allow idle rotation of the corresponding support rollers 61 and 62 when the traveling speed of the packaging material 11 is higher than the peripheral speed of each of the support rollers 61 and 62.

Thus, the first and second support rollers 61 and 62 do not resist travel of the packaging material 11′ and thus do not yield a braking effect, thereby allowing smooth travel of the packaging material 11.

Since the flexible drive cables 63 and 64 are used to transmit rotation of the drive motor, the drive motor can be located at an arbitrary position.

The present embodiment employs a single drive motor for rotating the first and second support rollers 61 and 62. However, a plurality of drive motors may be employed; for example, first and second drive motors may be employed to rotate the corresponding first and second support rollers 61 and 62 at the same speed or different speeds. When the first and second support rollers 61 and 62 are rotated at different speeds, at least one of the first and second support rollers 61 and 62 resists travel of the packaging material 11 to thereby induce torsion on the packaging material 11. Such torsion can be utilized for correcting the position of a longitudinally sealed portion; i.e., a longitudinal seal portion.

The present invention is not limited to the above-described embodiment. Numerous modifications and variations of the present invention are possible in light of the spirit of the present invention, and they are not excluded from the scope of the present invention.

### INDUSTRIAL APPLICABILITY

The present invention can be utilized for a filling apparatus adapted to fill liquid food into packaging containers.

1. A preforming apparatus comprising:
(a) a guide for forming a web-like packaging material into a tubular packaging material;
(b) a sealing device for longitudinally sealing said tubular packaging material;
(c) a drive unit; and
(d) a tube guide device disposed in such a manner as to surround said tubular packaging material, and guiding said tubular packaging material while being driven by means of said drive unit.

2. A preforming apparatus as described in claim 1, wherein said tube guide device is a support roller which receives rotation generated by means of said drive unit.

3. A preforming apparatus as described in claim 2, wherein a plurality of said support rollers are provided.

4. A preforming apparatus as described in claim 2, wherein each of said support rollers has a curved surface.

5. A preforming apparatus as described in claim 4, wherein a radius of curvature of said curved surface is substantially equal to that of said tubular packaging material.

6. A preforming apparatus as described in claim 2, wherein rotation is transmitted to said support roller via a one-way clutch.

7. A preforming apparatus as described in claim 1, wherein
(a) a plurality of said guides are disposed along a traveling direction of said packaging material for guiding said packaging material; and
(b) said tube guide device is disposed downstream of said guides with respect to the traveling direction of said packaging material.

8. A preforming apparatus as described in claim 1, wherein
(a) said preforming apparatus further comprises a longitudinal sealing device for longitudinally sealing said packaging material; and
(b) said tube guide device is disposed downstream of said longitudinal sealing device with respect to the traveling direction of said packaging material.

9. A preforming apparatus as described in claim 1, wherein
(a) said preforming apparatus further comprises a lateral sealing device for laterally sealing said packaging material; and
(b) said tube guide device is disposed upstream of said lateral sealing device with respect to the traveling direction of said packaging material.
